(19) United States
(12) Patent Application Publication
(10) Pub. No.: US 2013/0025432 A1
(43) Pub. Date: Jan. 31, 2013

(54) Combination carrying case and kick drum creep preventer

(71) Applicant: Christopher George Schaff, Morton, IL (US)

(72) Inventor: Christopher George Schaff, Morton, IL (US)

(21) Appl. No.: 13/136,212

(22) Filed: Jul. 27, 2011

(51) Int. Cl. G10D 13/02

(52) U.S. Cl. 84/422.2

(57) ABSTRACT

A combination carrying case and kick drum creep preventer that allows a drummer to conveniently transport items to a performance or rehearsal venue and prevent unwanted kick drum creep. The case is specially designed to open into a platform and provide a suitable area which is a kick drum placement area. Integrally attached to the case/platform structure near the kick drum placement area is a kick drum creep preventer that the kick drum can be placed against. Such a system provides a cost effective, simple and easy method for drummers to setup and play a kick drum along with other musical instruments without the problem of unwanted kick drum creep or motion.

### FIELD OF THE INVENTION

The present invention relates to preventing kick drum movement during play and a convenient method of transporting drum set hardware or other items.

### BACKGROUND OF THE INVENTION

Kick drum creep, or movement of a kick drum during play is a problem for many drummers who play drum set. While playing a typical drum set, most drummers use a kick drum that is played with a foot pedal. During heavy play with such a foot pedal many drummers experience kick drum movement away from the drummer as the kick drum is being played. Such movement during musical performance is distracting and uncomfortable for a drummer. It is important that while playing a kick drum, the drum remains stationary and does not move away from the drummer. The creep motion of a kick drum during play is a problem for many drummers.

The usual arrangement by which most drummers prevent kick drum creep is to place a heavy item in front of a kick drum. Some drummers use adhesive tape to hold a kick drum in place while others use a carpet with attached anchor.

One shortcoming of using a heavy item in front of a kick drum is the excessive weight or size of separate anchor. Such creep prevention requires transporting a large or heavy item in addition to the required instruments which causes additional effort. A shortcoming of using adhesive tape to prevent kick drum creep is that tape needs to be removed when the performance is complete and removed tape typically will leave a residue on the taped surface. Many types of tape will also not sufficiently prevent creep under very heavy playing. Using carpet with an attached anchor mechanism is cumbersome and requires carrying separate items in addition to a case full of drum set hardware.

It is therefore an object of the invention to provide creep prevention device for a kick drum.

It is another object of the invention to provide a specially designed carrying case with an integral kick drum creep prevention device built into the case structure.

It is another object of the invention to use the carrying case for drum set hardware to eliminate the need for separate independent kick drum anchor or adhesive tape to prevent kick drum creep.

It is another object of the invention to provide kick drum creep prevention device that is integral to a drum set hardware case to reduce setup time, improve cost effectiveness and eliminate extra items that require transport.

### SUMMARY OF THE INVENTION

In accordance with the present invention, there is provided a specially designed carrying case and kick drum creep prevention system that prevents creep motion of a kick drum during play with a foot pedal. The case is designed to open into a platform and provide a suitable area which is a kick drum placement area. Mounted onto the case/platform structure adjacent to the kick drum placement area is a kick drum creep preventer that the kick drum can be placed against. The case structure secures the creep preventer for the kick drum to eliminate forward motion away from the drummer using a foot pedal to play the kick drum. The system is designed to carry drum set hardware and other items and provide a decorative, visually appealing creep prevention device. This combination of carrying case and kick drum creep preventer will provide a cost effective, portable method of preventing unwanted creep or sliding of a kick drum during play.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a perspective view of a combination carrying case and kick drum creep preventer showing the case structure of the closed case and handle;

FIG. 2 is a perspective top view of a combination case and kick drum creep preventer with case opening to show the case interior and items inside the case;

FIG. 3 is a perspective view of a combination carrying case and kick drum creep preventer partially open;

FIG. 4 is a perspective top view of a combination case and kick drum creep preventer in open platform state showing the kick drum placement area;

FIG. 5 is a perspective view of a combination carrying case and kick drum creep preventer in use;

FIG. 6 is a perspective view of a combination carrying case and kick drum creep preventer in use from a front view; and

FIG. 7 is a perspective view of a combination carrying case and kick drum creep preventer in use.

For purposes of clarity and brevity, like elements and components will bear the same designations and numbering throughout the FIGURES.

### DESCRIPTION OF THE PREFERRED EMBODIMENT

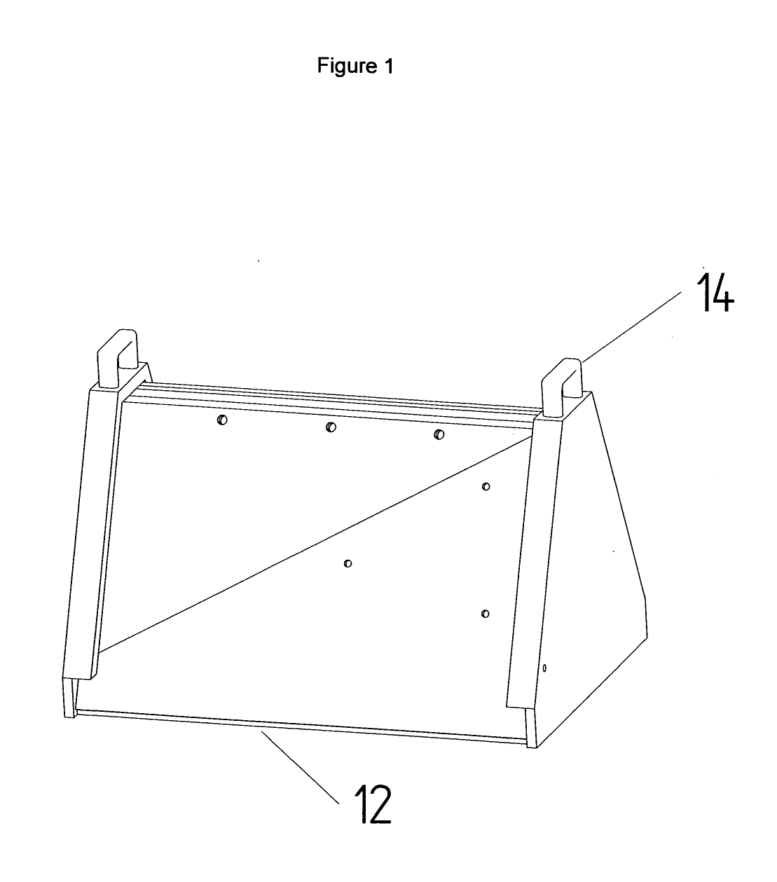

FIG. 1 is a perspective view of a combination carrying case 12 and kick drum creep preventer 10 showing the exterior of the case structure 16 and handle 14.

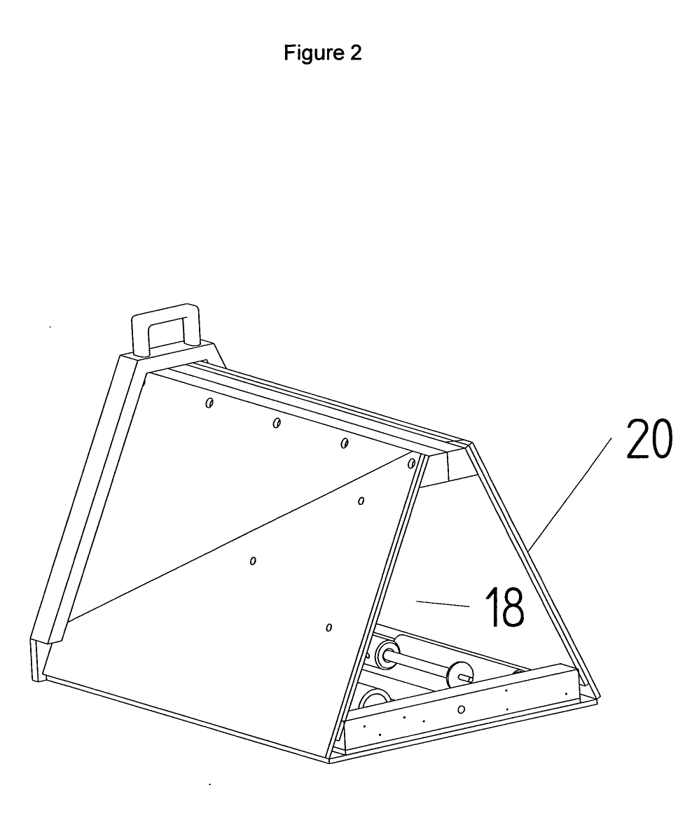

FIG. 2 is a perspective top view of a combination case and kick drum creep preventer 10 with case opening 20 to show the case interior 18 and items inside the case.

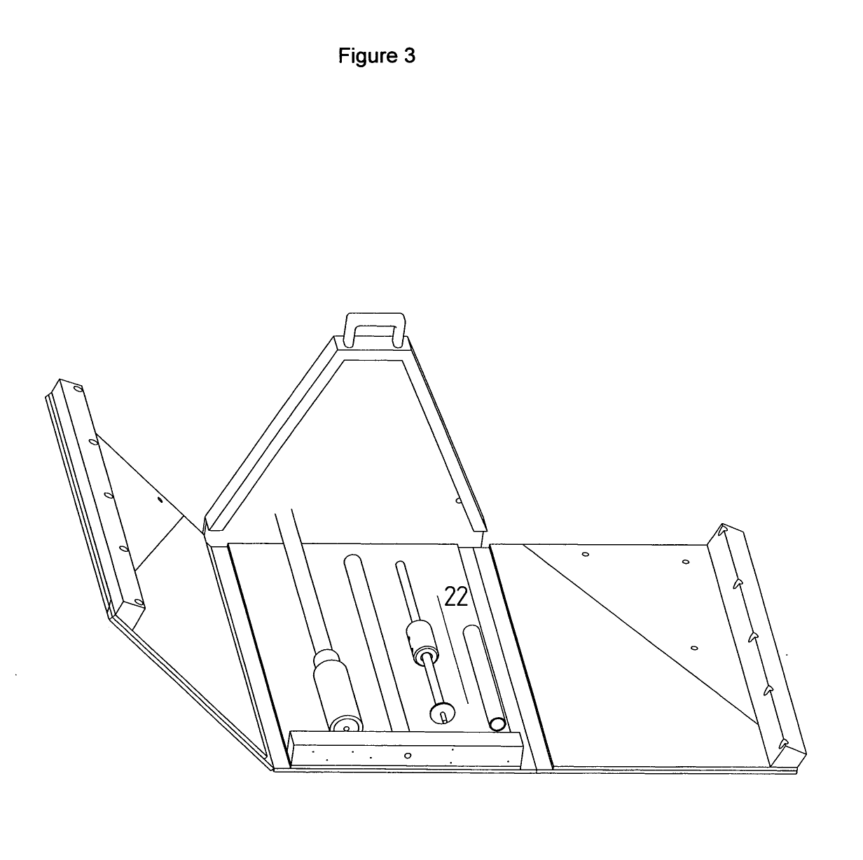

FIG. 3 is a perspective view of a combination carrying case 12 and kick drum creep preventer 10 partially open.

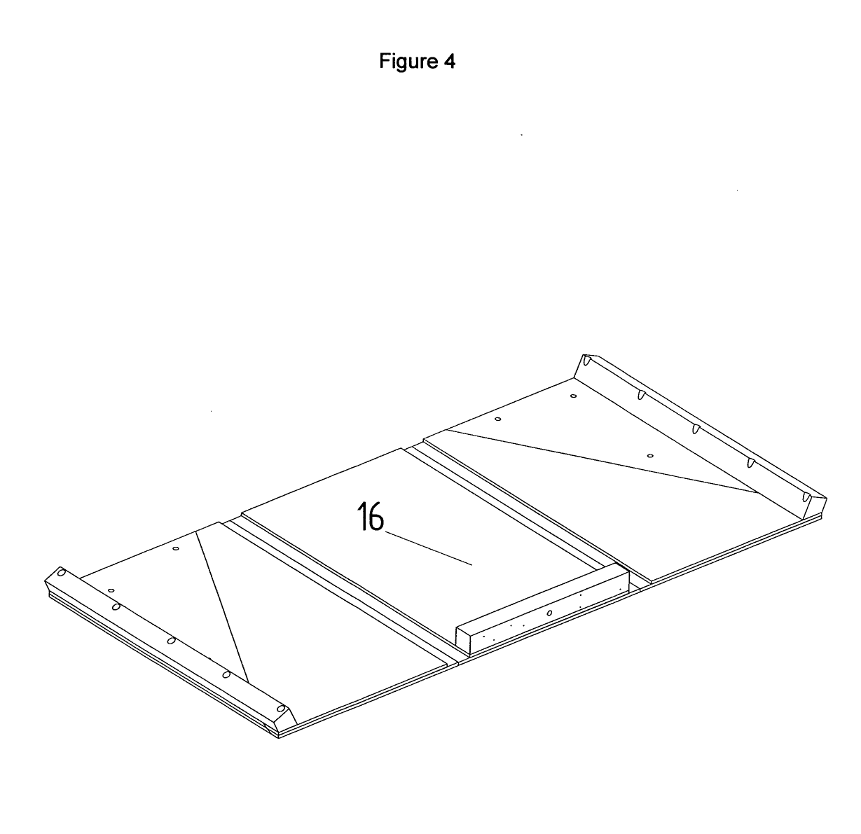

FIG. 4 is a perspective top view of a combination case and kick drum creep preventer 10 in open state showing the kick drum placement area 22

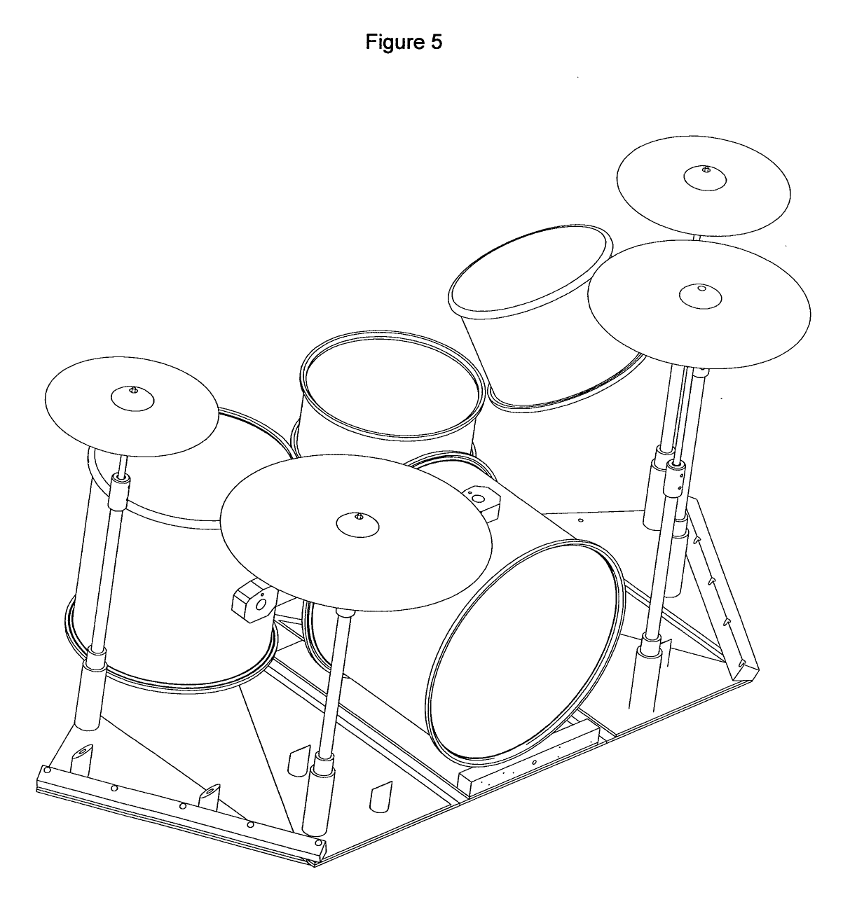

FIG. 5 is a perspective view of a combination carrying case 12 and kick drum creep preventer 10 in use.

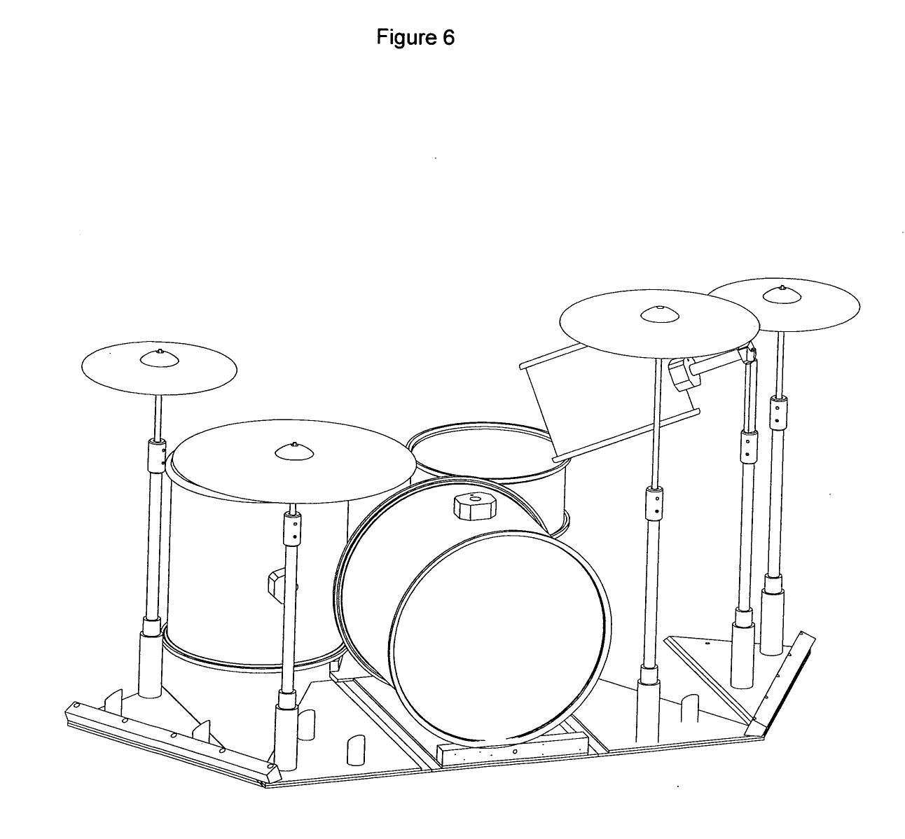

FIG. 6 is a perspective view of a combination carrying case 12 and kick drum creep preventer 10 in use from a front view.

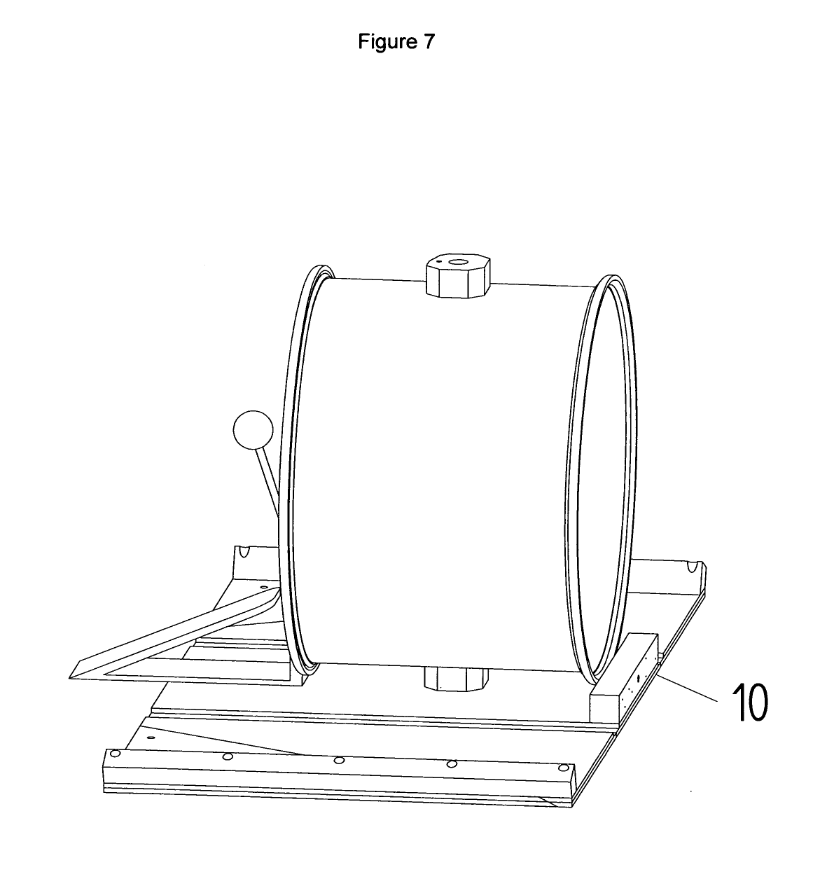

FIG. 7 is a side view of a combination carrying case 12 and kick drum creep preventer 10 in use.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A combination carrying case and kick drum creep preventer for transporting hardware and anchoring a kick drum or bass drum comprising:
means for preventing kick drum motion or creep;
means for carrying drum set hardware or other items;
means for providing a convenient method of carrying the case, rigidly connected to said means for carrying drum set hardware or other items;
means for providing structure for a carrying case and kick drum creep preventer, conveniently connected to said means for providing a convenient method of carrying the case, supportively encompassing to said means for carrying drum set hardware or other items, and securely constructed to said means for preventing kick drum motion or creep;
means for providing area within the case for placing drum set hardware or other items for transport or storage;
means for allowing access to case contents, operably positioned to said means for providing area within the case for placing drum set hardware or other items for transport or storage, and conveniently constructed to said means for carrying drum set hardware or other items; and
means for providing a case structure and a rigid attachment platform to which a kick drum creep preventer can be mounted, generally positioned to said means for providing area within the case for placing drum set hardware or other items for transport or storage, and adjacently placed to said means for preventing kick drum motion or creep.

2. The combination carrying case and kick drum creep preventer in accordance with claim 1, wherein said means for preventing kick drum motion or creep comprises a kick drum creep preventer.

3. The combination carrying case and kick drum creep preventer in accordance with claim 1, wherein said means for carrying drum set hardware or other items comprises a carrying case.

4. The combination carrying case and kick drum creep preventer in accordance with claim 1, wherein said means for providing a convenient method of carrying the case comprises a handle.

5. The combination carrying case and kick drum creep preventer in accordance with claim 1, wherein said means for providing structure for a carrying case and kick drum creep preventer comprises a case structure.

6. The combination carrying case and kick drum creep preventer in accordance with claim 1, wherein said means for providing area within the case for placing drum set hardware or other items for transport or storage comprises a case interior.

7. The combination carrying case and kick drum creep preventer in accordance with claim 1, wherein said means for allowing access to case contents comprises a case opening.

8. The combination carrying case and kick drum creep preventer in accordance with claim 1, wherein said means for providing a case structure and a rigid attachment platform to which a kick drum creep preventer can be mounted comprises a kick drum placement area.

9. A combination carrying case and kick drum creep preventer for transporting hardware and anchoring a kick drum or bass drum comprising:
a kick drum creep preventer, for preventing kick drum motion or creep;
a carrying case, for carrying drum set hardware or other items;
a handle, for providing a convenient method of carrying the case, rigidly connected to said carrying case;
a case structure, for providing structure for a carrying case and kick drum creep preventer, conveniently connected to said handle, supportively encompassing to said carrying case, and securely constructed to said kick drum creep preventer;
a case interior, for providing area within the case for placing drum set hardware or other items for transport or storage;
a case opening, for allowing access to case contents, operably positioned to said case interior, and conveniently constructed to said carrying case; and
a kick drum placement area, for providing a case structure and a rigid attachment platform to which a kick drum creep preventer can be mounted, generally positioned to said case interior, and adjacently placed to said kick drum creep preventer.

10. A combination carrying case and kick drum creep preventer for transporting hardware and anchoring a kick drum or bass drum comprising:
a kick drum creep preventer, for preventing kick drum motion or creep;
a carrying case, for carrying drum set hardware or other items;
a handle, for providing a convenient method of carrying the case, rigidly connected to said carrying case;
a case structure, for providing structure for a carrying case and kick drum creep preventer, conveniently connected to said handle, supportively encompassing to said carrying case, and securely constructed to said kick drum creep preventer;
a case interior, for providing area within the case for placing drum set hardware or other items for transport or storage;
a case opening, for allowing access to case contents, operably positioned to said case interior, and conveniently constructed to said carrying case; and
a kick drum placement area, for providing a case structure and a rigid attachment platform to which a kick drum creep preventer can be mounted, generally positioned to said case interior, and adjacently placed to said kick drum creep preventer.
